(19) United States
(12) Patent Application Publication
(10) Pub. No.: US 2015/0200731 A1
(43) Pub. Date: Jul. 16, 2015

(54) Sub-Sampled Carrier Phase Recovery

(71) Applicant: Cisco Technology, Inc., San Jose, CA (US)

(72) Inventors: Andreas Bisplinghoff, Hallerndorf (DE); Chris Fludger, Nuremberg (DE)

(73) Assignee: Cisco Technology, Inc., San Jose, CA (US)

(21) Appl. No.: 14/154,674

(22) Filed: Jan. 14, 2014

(51) Int. Cl. H04B 10/61; H04L 7/04; H04L 7/00

(52) U.S. Cl. CPC H04B 10/6165; H04L 7/0075; H04L 7/048

(57) ABSTRACT

Presented herein are sub-sampled carrier phase recovery techniques. In accordance with one example, a plurality of consecutive symbols associated with a received optical signal is obtained. Carrier phase recovery of the optical signal is performed using one or more carrier phase estimation stages. At each of the one or more carrier phase estimation stages, a subset of the plurality of consecutive symbols is selected for use in carrier phase estimation. The subset of symbols selected for use in carrier phase estimation at each of the one or more stages comprises symbols that provide the most phase recovery information for each of the one or more stages.

### TECHNICAL FIELD

The present disclosure relates to carrier phase recovery in an optical receiver.

### BACKGROUND

In recent years there has been an increase in the use of optical fiber communication networks. In an optical fiber communication network, an optical transmitter takes an electrical input and converts it to an optical output using a light source (e.g., laser diode, Light Emitting Diode (LED), etc.). The light from the transmitter is coupled into an optical fiber and is transmitted through the optical fiber to an optical receiver. The optical receiver converts the light back into an electrical signal.

Early optical fiber communication networks used transmission of one bit of information per data symbol. However, due to the need for high-capacity communications, there is an increasing demand for higher bit rates. This has led to the use of higher order modulation schemes for optical transmissions. Modulation schemes that have been implemented include, for example, Quaternary Phase Shift Keying (QPSK) and M-Quadrature Amplitude Modulation (M-QAM), wherein M is an integer with the power of 2 (i.e., 2, 4, 8, 16, 32, 64, etc.). In such modulation schemes, the optical transmitter includes an optical modulator that modulates the optical signal to carry the additional data.

### BRIEF DESCRIPTION OF THE DRAWINGS

FIG. 1 is a block diagram of an optical receiver configured to execute sub-sampled carrier phase recovery techniques in accordance with examples presented herein.

FIG. 2A is a schematic diagram of a parallelized Viterbi-Viterbi carrier phase estimation stage in accordance with examples presented herein.

FIG. 2B is a schematic diagram illustrating sub-sampling and symbol selection logic in accordance with examples presented herein.

FIG. 3 is a schematic diagram illustrating ring partitioning in accordance with examples presented herein.

FIG. 4 is a schematic diagram of a two-stage carrier phase estimation with sub-sampled Viterbi-Viterbi and Maximum-Likelihood carrier phase estimation stages in accordance with examples presented herein.

FIG. 5 is a schematic diagram of another two-stage carrier phase estimation with sub-sampled Viterbi-Viterbi and Maximum-Likelihood carrier phase estimation stages in accordance with examples presented herein.

FIG. 6 is a schematic diagram of still another two-stage carrier phase estimation with sub-sampled Viterbi-Viterbi and Maximum-Likelihood carrier phase estimation stages in accordance with examples presented herein.

FIG. 7 is a flowchart of a sub-sampled carrier phase recovery technique in accordance with examples presented herein.

### DESCRIPTION OF EXAMPLE EMBODIMENTS

### Overview

Presented herein are sub-sampled carrier phase recovery techniques. In accordance with one example, a plurality of consecutive symbols associated with a received optical signal is obtained. Carrier phase recovery of the optical signal is performed using one or more carrier phase estimation stages. At each of the one or more carrier phase estimation stages, a subset of the plurality of consecutive symbols is selected for use in carrier phase estimation. The subset of symbols selected for use in carrier phase estimation at each of the one or more stages comprises symbols that provide the most phase information about the optical signal that is relevant for phase error estimation in each of the one or more stages.

### Example Embodiments

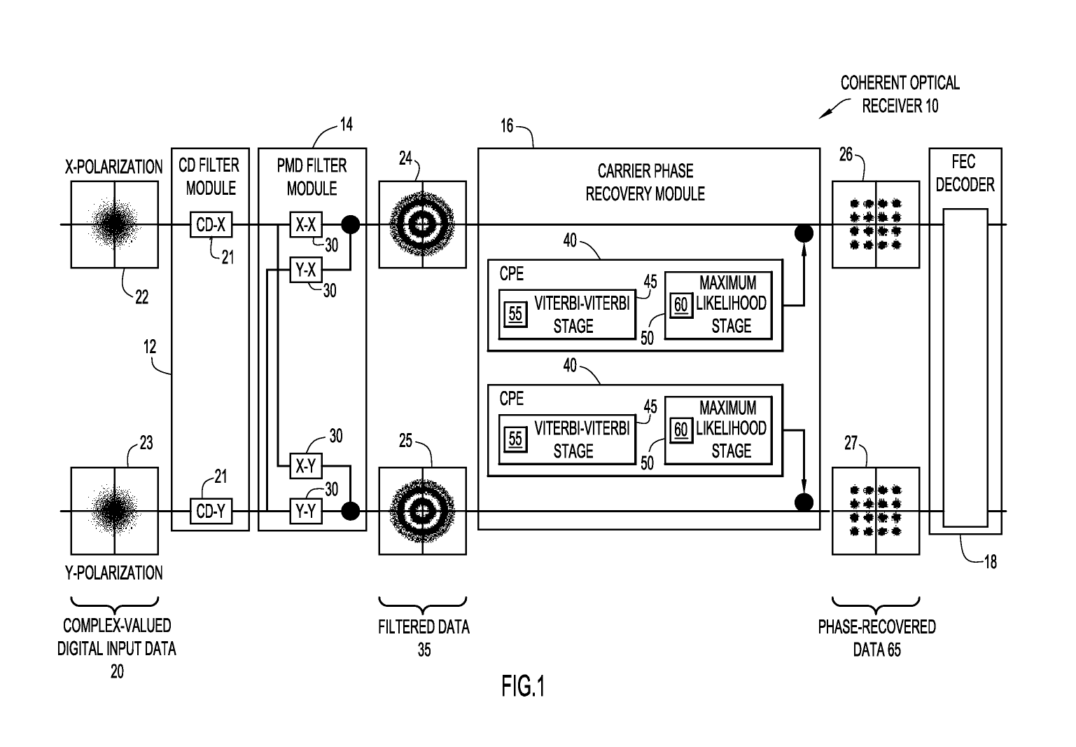

FIG. 1 is a block diagram illustrating part of a coherent optical receiver 10 configured to perform sub-sampled carrier phase recovery techniques in accordance with examples presented herein. The illustrated portion of optical receiver 10 comprises a chromatic dispersion (CD) filter module 12, a polarization-mode dispersion (PMD) filter module 14, a carrier phase recovery module 16, and a Forward Error Correction (FEC) decoder 18. The optical receiver 10 is a Polarization Multiplexed 16-Quadrature Amplitude Modulation (PM-16-QAM) optical receiver. That is, optical receiver 10 is configured to process and decode optical signals modulated in accordance with a modulation scheme that uses four in-phase (I) and four quadrature (Q) values that yield four bits per symbol, creating 16 possible states.

Complex-valued digital input data 20 is received and processed by the chromatic dispersion filter module 12 and the polarization-mode dispersion filter module 14. As shown, the complex-valued digital input data 20 comprises X-polarized components in a scattered arrangement 22 and Y-polarized components in a scattered arrangement 23. The chromatic dispersion filter module 12 may comprise one or more filters 21 for application to the X-polarized and Y-polarized components to compensate for the chromatic dispersion in the complex-valued digital input data 20. Similarly, the polarization-mode dispersion filter module 14 may comprise one or more filters 30 for application to the X-polarized and Y-polarized components to compensate for the polarization-mode dispersion in the complex-valued digital input data 20.

Filtered data 35 (i.e., data processed by the chromatic dispersion filter module 12 and the polarization-mode dispersion filter module 14) is provided to the carrier phase recovery module 16. The filtered data 35 includes X-polarized components in a ring-shaped pattern 24 and Y-polarized components in a ring-shaped pattern 25.

The carrier phase recovery module 16 comprises two carrier phase estimation (CPE) blocks 40 each of which are associated with one of the X-polarized components and Y-polarized components. The X-polarized components and Y-polarized components may exchange phase estimation results to increase the overall estimation accuracy. The carrier phase estimation blocks 40 each comprise a Viterbi-Viterbi carrier phase estimation stage (Viterbi-Viterbi stage) 45 and a Maximum-Likelihood carrier phase estimation stage (Maximum-Likelihood stage) 50. The Viterbi-Viterbi stages 45 each comprise Viterbi-Viterbi sub-sampling selection logic 55, while the Maximum-Likelihood stages 50 each comprise Maximum-Likelihood sub-sampling selection logic 60.

In general, phase error is induced by an optical channel and phase noise associated with the finite line width of the transmit laser and local-oscillator laser receiver. The carrier phase recovery module 16 is configured to estimate the phase error and use that phase error to generate phase recovered data 65. That is, the carrier phase recovery module 16 is configured to use the estimated phase error to convert the ring shaped patterns 24 and 25 in the filtered data 35 to respective 16-QAM constellations (i.e. constellations from which the phase error has been removed) 26 and 27. FIG. 1 illustrates the standard 16-QAM constellations 26 (corresponding to the X-polarized components) and 27 (corresponding to the Y-polarized components) forming part of the phase-recovered data 65. The phase-recovered data 65 is provided to Forward Error Correction (FEC) decoder 18.

Certain conventional techniques perform carrier phase estimation based on all received symbols. These conventional methods are accurate and provide good tolerance to laser phase noise, non-linear phase noise, and local oscillator (LO)-frequency offset. However, these methods are also complex and may consume significant amounts of power. Presented herein are techniques that select a subset of symbols for use in one or more carrier phase estimation stages in order to reduce the power requirements associated with the carrier phase recovery. The techniques presented herein select the subset of symbols in a manner that substantially maintains a high level performance achieved with techniques that use all received symbols for carrier phase recovery.

More specifically, as described further below, the carrier phase estimation blocks 40 of FIG. 1 are configured to implement sub-sampling selection techniques in which only certain symbols (i.e., a subset of the received symbols) are used during carrier phase recovery (e.g., in each of the Viterbi-Viterbi carrier phase estimation stages 45 and the Maximum-Likelihood carrier phase estimation stages 50). The symbols selected for use in each stage are, in general, the symbols with the highest ratio between the measured signal phase error and additive noise. That is, the symbols that provide the most phase information about the received optical signal that is relevant for a specific stage are selected for use in that stage. The “most phase information about the received optical signal that is relevant for a specific stage” refers to the most available phase recovery information for a given stage. For instance, the Viterbi-Viterbi carrier phase estimation is unable to use constellation points in the 2^{nd} ring, whilst constellation points in the outer rings give the minimum phase error for a given amount of additive noise.

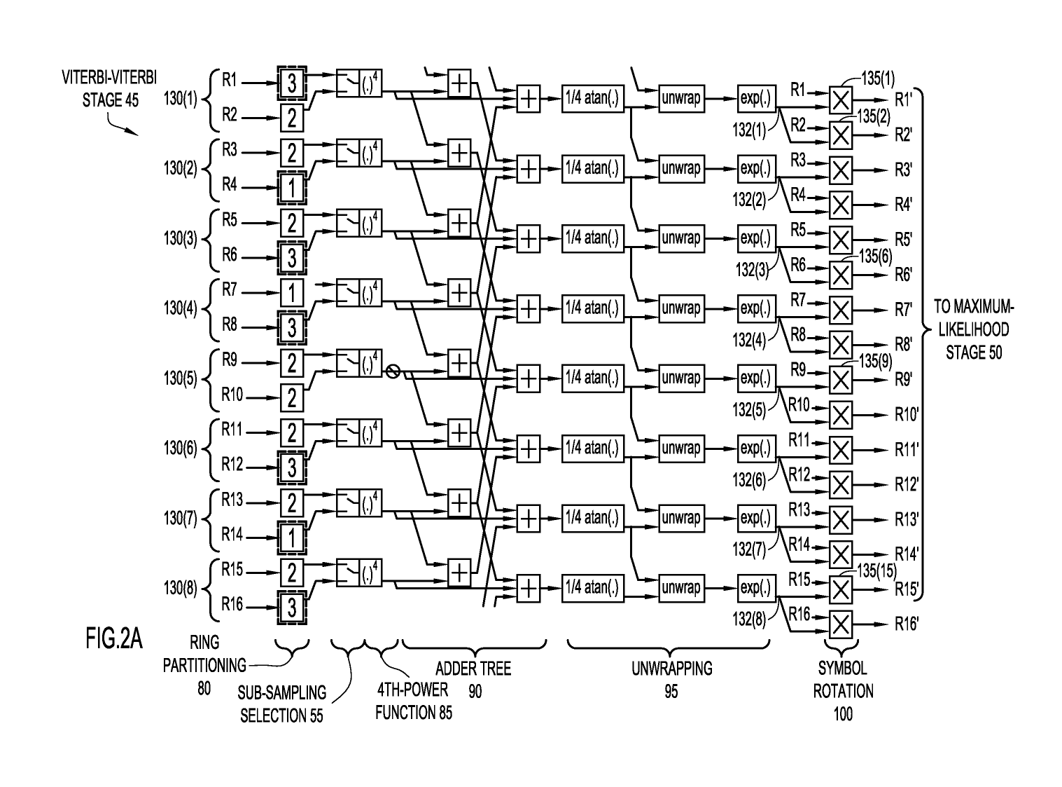

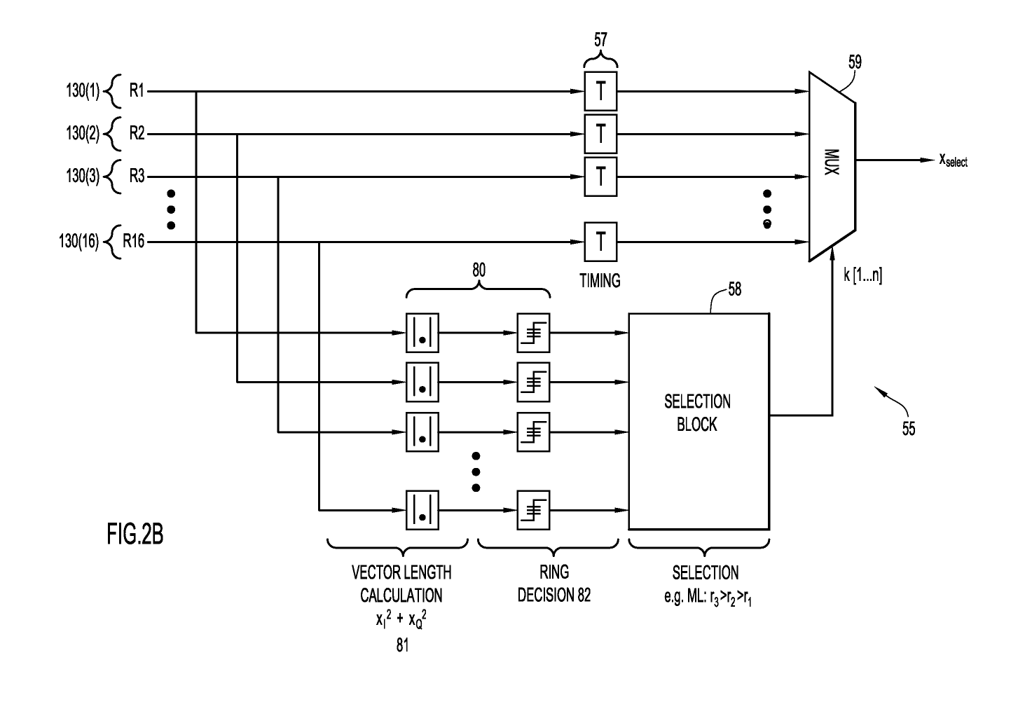

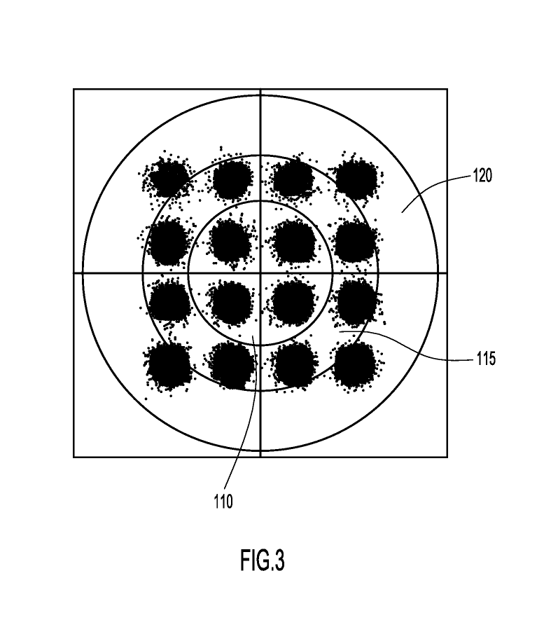

Reference is now made to FIGS. 2A, 2B, and 3. FIG. 2A is a schematic diagram illustrating sub-sampling selection techniques in an example Viterbi-Viterbi carrier phase estimation stage 45 in accordance with examples presented herein. As shown, the Viterbi-Viterbi stage 45 comprises a ring partitioning segment 80, the aforementioned sub-sampling selection logic 55, a 4^{th}-power function segment 85, an adder tree segment 90 (for moving average filtering), an unwrapping segment 95 (vector-to-angle conversion, unwrapping, phase-to-vector conversion), and a symbol rotation segment 100.

In operation, optical signals are received at an optical receiver at a high rate (e.g., at a rate of 32 giga-baud (GBAUD), but the application-specific integrated circuit (ASIC) of the optical receiver and/or other hardware components are typically clocked at a lower rate (e.g., they operate with a 500 Megahertz (MHz) clock). Therefore, the Viterbi-Viterbi stage 45 operates on a plurality of symbols in parallel. In the example of FIG. 2A, 16 symbols are received and processed in parallel and are referred to as symbols R1 through R16. It is to be appreciated that the use of 16 symbols is merely illustrative and that different numbers of symbols (e.g., 12, 32, 96, 108, etc.) could be processed in parallel, depending on the capabilities of the ASIC and/or other hardware components.

The parallel processing of a plurality (e.g., 16) of symbols through the entire Viterbi-Viterbi stage 45 may consume significant power. The sub-sampling selection techniques presented herein reduce the number of symbols processed at various segments of the Viterbi-Viterbi stage 45, thereby reducing the power consumed by the Viterbi-Viterbi stage 45.

A 4^{th}-power function is an operation applicable to Quaternary Phase Shift Keying (QPSK) signals for phase error estimation. The 4^{th}-power function segment 85 is used to remove the QPSK signals, thereby leaving only the phase error and additive noise. That is, the 4^{th}-power function segment 85 generates a vector from which the data has been removed. For 16-QAM the 4^{th}-power function cannot be directly applied in the same way as with QPSK signals. Therefore, a so-called “ring partitioning” approach is used in which, as shown in FIG. 3, a 16-QAM constellation is generally divided into three rings, namely a first (inner) ring 110, a second (middle) ring 115, and a third (outer) ring 120. The rings, sometimes referred to herein as constellation radius rings, are used to group constellation points (symbols) into classes based on their distance from the center of the constellation.

More specifically, the first ring 110 is set a first distance from the center of the constellation (i.e., the first ring has a first radius representing the distance from the center of the constellation to the first ring). A number of symbols positioned less than this first distance from the center of the constellation will fall within the first ring 110. The second ring 115 is set a second distance from the center of the constellation (i.e., the second ring has a second radius representing the distance from the center to the second ring). A number of symbols positioned less than the second distance from the center of the constellation, but greater than the first distance will fall within the second ring 115. The third ring 120 is set a third distance from the center of the constellation (i.e., the third ring has a third radius representing the distance from the center to the third ring). A number of symbols positioned less than the third distance from the center of the constellation, but greater than the second distance will fall within the third ring 120.

The first ring 110 and the third ring 120 are both QPSK-like because they each include four symbol points. The second ring 115 is not QPSK-like because it includes eight symbol points (with unequal angular spacing). In the example configuration of the Viterbi-Viterbi stage of FIG. 2A, the ring partitioning is performed on the 16 received (original) symbols R1 through R16 at ring partitioning segment 80. That is, when a symbol is received, the ring partitioning segment 80 determines within which of the three rings 110, 115, or 120 the symbol falls.

As noted above, symbols R1 through R16 are received at ring partitioning segment 80. FIG. 2A illustrates, in ring partitioning segment 80, one box corresponding to each of these received symbols R1 through R16 that includes a number “1”, “2”, or “3” therein. The number within the box indicates the ring to which the received symbol belongs. For example, symbol R1 is associated with a box that includes the number “3” therein, indicating that symbol R1 falls in the third ring 120 (i.e., the ring partitioning segment 80 has classified symbol R1 as a member of the third ring 120). Symbols R2 and R3 are associated with boxes that include the number “2,” indicating that symbols R2 and R3 fall within the second ring 115; symbol R4 is associated with a box that includes the number “1,” indicating that symbol R4 falls within the first ring 110; and so on. Table 1, below, illustrates the received symbols of FIG. 2A and within which ring each of those symbols fall.

TABLE 1

| Symbol | Ring |
|---|---|
| Symbol R1 | Third Ring |
| Symbol R2 | Second Ring |
| Symbol R3 | Second Ring |
| Symbol R4 | First Ring |
| Symbol R5 | Second Ring |
| Symbol R6 | Third Ring |
| Symbol R7 | First Ring |
| Symbol R8 | Third Ring |
| Symbol R9 | Second Ring |
| Symbol R10 | Second Ring |
| Symbol R11 | Second Ring |
| Symbol R12 | Third Ring |
| Symbol R13 | Second Ring |
| Symbol R14 | First Ring |
| Symbol R15 | Second Ring |
| Symbol R16 | Third Ring |

The sub-sampling selection logic 55 is connected between the ring partitioning segment 80 and the 4^{th}-power function segment 85. The sub-sampling selection logic 55 is configured to select a subset of the received symbols R1 through R16 for processing by the subsequent segments in the Viterbi-Viterbi stage 45. In general, the symbols selected for subsequent use are the symbols that provide the most phase information about the optical signal that is relevant for phase error estimation in the subsequent Viterbi-Viterbi operations. More specifically, the 4^{th}-power function results in a vector of the phase of a symbol. Additive Gaussian noise on a symbol will cause a greater phase error for symbols which fall within lower rings. Therefore phase estimates from symbols in outer rings have more valuable information than those in inner rings and should be selected preferentially. In addition, the 4^{th} power operation results in a longer vector for outer rings and hence weights those phase estimations preferentially. Other techniques involve normalizing the 4th power vectors so that all are of the same length, and then applying a scaling (e.g. ×2, ×3, ×4) afterwards. The 4^{th}-power function may only be used with symbols that fall within the first ring 110 or the third ring 120 (i.e., cannot be applied to second ring symbols). As such, with regards to the application of the 4^{th}-power function to received symbols, the most phase information about the optical signal that is relevant for phase error estimation in a Viterbi-Viterbi stage can be obtained using third ring symbols, while the second most phase information for phase error estimation in a Viterbi-Viterbi stage can be obtained using first ring symbols, and no information can be obtained from second ring symbols.

In the example of FIG. 2A, the 16 received symbols R1 through R16 are organized (divided) into eight (8) groups 130(1)-130(8) that each comprises two sequential symbols (i.e. pairs of symbols). For example, group 130(1) includes symbols R1 and R2, group 130(2) includes symbols R3 and R4, and so on. As such, FIG. 2A illustrates a sub-sampling factor of 2 that has approximately half of the complexity of a conventional approach that processes all parallel symbols. The sub-sampling logic 55 is configured to evaluate the symbols within a group to select the symbol in that group that, when the 4^{th}-power function is applied thereto, will provide the most phase information about the optical signal that is relevant for phase error estimation in a Viterbi-Viterbi stage (i.e., identify the symbol with the highest ratio between the measured signal phase error and additive noise and which is useable in the Viterbi-Viterbi stage. For example, as noted, group 130(1) comprises symbols R1 and R2. R1 falls within the third ring 120, while R2 falls within the second ring 115. Third ring symbols provide the most information for phase error correction (i.e., have the highest ratio between the measured signal phase error and additive noise). Second ring symbols have the second highest ratio between the measured signal phase error and additive noise, but cannot be used with the 4^{th}-power function and thus do not provide any information for phase error correction in the Viterbi-Viterbi stage 45. As such, from group 130(1) symbol R1 is selected for subsequent processing by the 4^{th}-power function segment 85, while symbol R2 is discarded (i.e., omitted for use in processing by the 4^{th}-power function segment 85).

As a further example, group 130(4) comprises symbols R7 and R8. R7 falls within the first ring 110, while R8 falls within the third ring 120. Third ring symbols have the highest ratio between the measured signal phase error and additive noise, while first ring symbols have the lowest ratio between the measured signal phase error and additive noise. As such, from group 130(4), symbol R8 is selected for subsequent processing by the 4^{th}-power function segment 85, while symbol R7 is discarded.

Furthermore, group 130(5) comprises symbols R9 and R10 that both fall within the second ring 115. As noted, second ring symbols cannot be used with the 4^{th}-power function and thus do not provide any information for phase error correction in the Viterbi-Viterbi stage 45. As such, no symbols from group 130(5) are selected for subsequent processing by the 4^{th}-power function segment 85. That is, both symbols R9 and R10 are discarded.

The symbols that are selected from each group 130(1)-130(8) are circled in FIG. 2A. Additionally, Table 2 below illustrates each of the groups 130(1)-130(8), the symbols in each group, the symbol that is selected for subsequent Viterbi-Viterbi stage operations, and the selected symbol ring classification.

| | First Group | Second Group | Selected | Selected Symbol |
|---|---|---|---|---|
| Group | Member | Member | Symbol | Ring |
| 130(1) | Symbol R1 | Symbol R2 | Symbol R1 | Ring 3 |
| 130(2) | Symbol R3 | Symbol R4 | Symbol R4 | Ring 1 |
| 130(3) | Symbol R5 | Symbol R6 | Symbol R6 | Ring 3 |
| 130(4) | Symbol R7 | Symbol R8 | Symbol R8 | Ring 3 |
| 130(5) | Symbol R9 | Symbol R10 | None | None |
| 130(6) | Symbol R11 | Symbol R12 | Symbol R12 | Ring 3 |
| 130(7) | Symbol R13 | Symbol R14 | Symbol R14 | Ring 1 |
| 130(8) | Symbol R15 | Symbol R14 | Symbol R16 | Ring 3 |

As noted above, the ring partitioning segment 80 determines within which ring a received symbol falls. The sub-sampling selection logic 55 comprises one or more hardware elements (e.g., switches, multiplexers, etc.) that use the ring partitioning segment information to select the appropriate symbols. Further details of the sub-sampling and symbol selection logic 55 are provided below with reference to FIG. 2B. In essence, the sub-sampling selection logic 55 is configured to perform a comparison of the symbols within a group 130(1)-130(8) to determine which one has the highest relative ratio between the measured signal phase error and additive noise and is useable for phase error estimation in the subsequent Viterbi-Viterbi operations.

FIG. 2A illustrates an example in which the groups 130(1)-130(8) each have two members and where one symbol is selected from each group. It is to be appreciated that these examples are merely illustrative and that other group sizes (e.g., groups of 4 symbols) are possible.

In the example of FIG. 2A, as a result of the sub-sampling selection logic 55, seven symbols are selected for processing by the 4^{th}-power function segment 85. As noted, the 4^{th}-power function segment 85 produces vectors from which the original data has been removed. These vectors are then provided to the adder tree segment 90.

Each of the received symbols has some noise associated therewith. The adder tree segment 90 is configured to use the vectors provided by the 4^{th}-power function segment 85 to generate, for each group 130(1)-130(8), an averaged vector over a sliding/moving window. This process reduces noise in the vectors.

It should be noted that the group 130(5) associated with R9 and R10 does not provide any symbol to the 4^{th}-power function segment 85. Accordingly, the 4^{th}-power function segment 85 does not provide a vector to the adder tree segment 90. However, due to the averaging function of the adder tree segment 90, an output for group 130(5) is still produced (using the surrounding vectors) by the adder tree segment 90 that may be used for subsequent processing.

The averaged vectors for groups 130(1)-130(8) produced by adder tree segment 90 are provided to the unwrap segment 95 to remove occasional phase jumps because of the 90 degree phase ambiguity (4^{th} power function). Using the averaged vectors, the unwrapping segment 95 generates a Viterbi-Viterbi estimated phase correction (offset) 132(1)-132(8) for each group. At the symbol rotation segment 100, the Viterbi-Viterbi estimated phase corrections 132(1)-132(8) are then applied to the original symbols in the respective group.

More specifically, at the symbol rotation segment 100, each of the original symbols R1 through R16 are provided to an associated processing block 135(1)-135(16). Each block also receives a Viterbi-Viterbi stage phase error correction for the corresponding group. For example, blocks 135(1) and 135(2) receive the original symbols R1 and R2, respectively. The blocks 135(1) and 135(2) also receive the Viterbi-Viterbi stage phase error correction 132(1) corresponding to group 130(1) to which symbols R1 and R2 belong. That is, the Viterbi-Viterbi stage phase error correction 132(1) generated from R1 is used for the phase error correction of both symbols R1 and R2 at the symbol rotation segment 100. Table 3, below, illustrates the Viterbi-Viterbi stage phase error correction signal that is used to correct each of the symbols R1 through R16 at the symbol rotation segment 100.

TABLE 3

| Symbol | Correction Signal |
|---|---|
| Symbol R1 | 132(1) |
| Symbol R2 | 132(1) |
| Symbol R3 | 132(2) |
| Symbol R4 | 132(2) |
| Symbol R5 | 132(3) |
| Symbol R6 | 132(3) |
| Symbol R7 | 132(4) |
| Symbol R8 | 132(4) |
| Symbol R9 | 132(5) |
| Symbol R10 | 132(5) |
| Symbol R11 | 132(6) |
| Symbol R12 | 132(6) |
| Symbol R13 | 132(7) |
| Symbol R14 | 132(7) |
| Symbol R15 | 132(8) |
| Symbol R16 | 132(8) |

The symbol rotation segment 100 is configured to output a plurality of Viterbi-Viterbi phase error corrected signals, shown in FIG. 2A as symbols R1′ though R16′. These symbols R1′ through R16′ may then be provided to the Maximum-Likelihood stage 50 of the phase error correction module 40 for additional phase correction, as described further below.

It should be noted that if the subsequent Maximum-Likelihood stage 50 is also sub-sampled, it is sufficient to apply the symbol rotation segment only to those symbols that will be used in the Maximum-Likelihood stage 50. This further reduces complexity and power dissipation.

As noted, FIG. 2B is a schematic diagram illustrating further details of the sub-sampling selection logic 55 and ring portioning segment 80. As shown, symbols R1 through R16 are received and provided to the ring portioning segment 80 and a timing segment 57. The ring portioning segment 80 includes a vector length calculation block 81 that feeds a ring decision block 82. The output from the ring decision block 82 is provided to selection block 58. The sub-sampling selection logic 55 also comprises a multiplexer 59 connected to the timing block 57 and the selection block 58 that uses the signals from these blocks to generate an output (X_{select}) representing the selected symbol for a group of symbols.

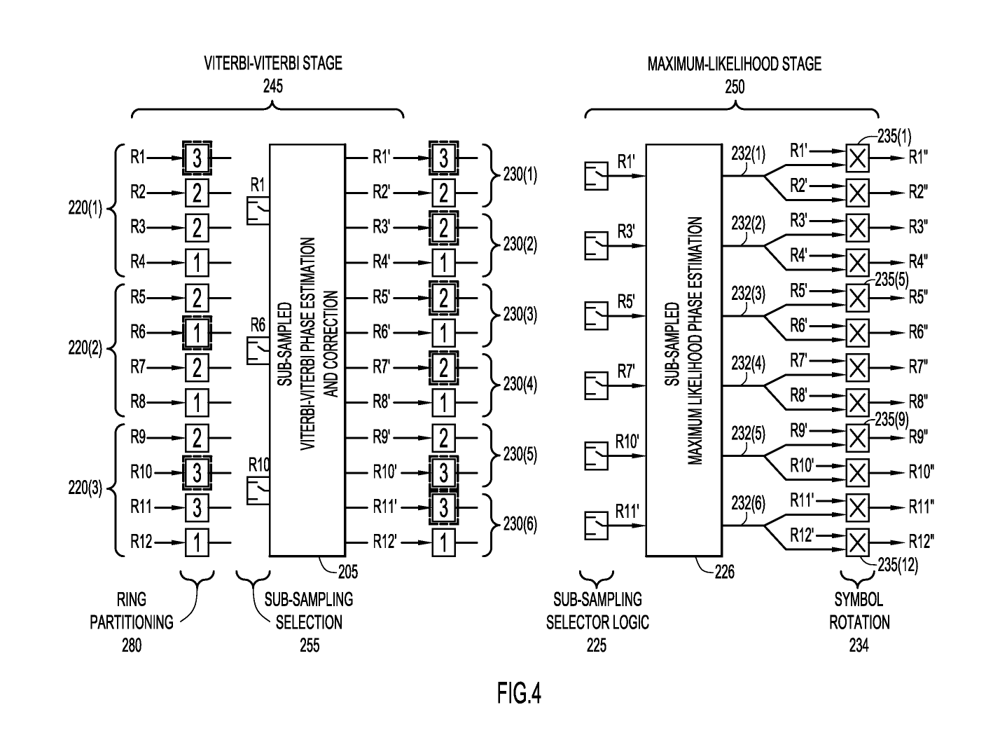

FIG. 4 is a schematic diagram illustrating sub-sampling selection techniques in an example Maximum-Likelihood stage 250 connected to a Viterbi-Viterbi stage 245. As noted above, optical signals are received at an optical receiver at a high rate (e.g., at a rate of 32 GBAUD, but the receiver ASIC and/or other hardware components are typically clocked at a lower rate (e.g., they operate with a 500 MHz clock). Therefore, the Viterbi-Viterbi stage 245 and Maximum-Likelihood stage 250 operate on a plurality of symbols in parallel. In the example of FIG. 4, 12 symbols are received and processed in parallel and are referred to as received (original) symbols R1 through R12. It is to be appreciated that the use of 12 symbols is merely illustrative and that different numbers of symbols (e.g., 12, 32, 96, 108, etc.) could be processed in parallel, depending on the capabilities of the ASIC and/or other hardware components.

The parallel processing of a plurality (e.g., 12) symbols through the Viterbi-Viterbi stage 245 and Maximum-Likelihood stage 250 may consume significant power. The sub-sampling selection techniques presented herein reduce the number of symbols processed at various segments of both the Viterbi-Viterbi stage 245 and the Maximum-Likelihood stage 250, thereby reducing the power consumed at the optical receiver.

In the example of FIG. 4, the Viterbi-Viterbi stage 245 operates substantially the same as described above with reference to FIG. 2A to generate a plurality of Viterbi-Viterbi phase error corrected signals, shown in FIG. 4 as symbols R1′ though R12′. More specifically, the Viterbi-Viterbi stage 245 includes a ring partitioning segment 280 configured to determine within which of the three rings 110, 115, or 120 (as shown in FIG. 3) each of the received symbols R1 through R12 falls. FIG. 4 illustrates, in ring partitioning segment 280, one box corresponding to each of the received symbols that includes a number “1”, “2”, or “3” therein. The number within the box indicates the ring to which the received symbol belongs. Table 4, below, illustrates the received symbols R1 through R12 of FIG. 4 and which ring each of those symbols fall within.

TABLE 4

| Symbol | Ring |
|---|---|
| Symbol R1 | Third Ring |
| Symbol R2 | Second Ring |
| Symbol R3 | Second Ring |
| Symbol R4 | First Ring |
| Symbol R5 | Second Ring |
| Symbol R6 | First Ring |
| Symbol R7 | Second Ring |
| Symbol R8 | First Ring |
| Symbol R9 | Second Ring |
| Symbol R10 | Third Ring |
| Symbol R11 | Third Ring |
| Symbol R12 | First Ring |

As shown, sub-sampling selection logic 255 is connected between the ring partitioning segment 280 and a sub-sampled Viterbi-Viterbi phase estimation and correction block 205. The sub-sampling selection logic 255 is, similar to the sub-sampling logic 55 of FIG. 2A, configured to select a subset of the received symbols R1 through R12 for processing by the subsequent segments in the Viterbi-Viterbi stage 245. In general, the symbols selected for subsequent use are the symbols that provide the most phase information about the optical signal that is relevant for phase error estimation in the subsequent Viterbi-Viterbi operations.

More specifically, as noted above, the 4^{th}-power function results in a vector of the phase of a symbol. Additive Gaussian noise on a symbol will cause a greater phase error for symbols which fall within lower rings. Therefore phase estimates from symbols in outer rings have more valuable information than those in inner rings and should be selected preferentially. In addition, the 4^{th} power operation results in a longer vector for outer rings and hence weights those phase estimations preferentially. Other techniques involve normalizing the 4^{th} power vectors so that all are of the same length, and then applying a scaling (e.g. ×2, ×3, ×4) afterwards. The 4^{th}-power function may only be used with symbols that fall within the first ring 110 or the third ring 120 (i.e., cannot be applied to second ring symbols). As such, with regards to the application of the 4^{th}-power function to received symbols, the most phase information about the optical signal that is relevant for phase error estimation in a Viterbi-Viterbi stage can be obtained using third ring symbols, while the second most phase information for phase error estimation in a Viterbi-Viterbi stage can be obtained using first ring symbols, and no information can be obtained from second ring symbols.

In the example of FIG. 4, the 12 received symbols R1 through R12 are divided into three (3) groups 220(1), 220(2), and 220(3) that each comprises four sequential symbols. For example, group 220(1) includes symbols R1-R4, group 220(2) includes symbols R5-R8, and group 220(3) includes symbols R9-R12. The sub-sampling logic 255 is configured to evaluate the symbols within each of the groups 220(1)-220(3) to select the symbol in that group that, when the 4^{th}-power function is applied thereto, will provide the most information for phase error correction. The symbols that are selected from each group 220(1), 220(2), and 220(3) are circled in FIG. 4. Additionally, Table 5 below illustrates each of the groups 220(1), 220(2), and 220(3); the symbols in each group, the symbol that is selected for subsequent Viterbi-Viterbi stage operations, and the selected symbol ring classification.

TABLE 5

| | First | Second | Third | Fourth | | Selected |
|---|---|---|---|---|---|---|
| | Group | Group | Group | Group | Selected | Symbol |
| Group | Member | Member | Member | Member | Symbol | Ring |
| 220(1) | Symbol R1 | Symbol R2 | Symbol R3 | Symbol R4 | Symbol R1 | Ring 3 |
| 220(2) | Symbol R5 | Symbol R6 | Symbol R7 | Symbol R8 | Symbol R6 | Ring 1 |
| 220(3) | Symbol R9 | Symbol R10 | Symbol R11 | Symbol R12 | Symbol R10 | Ring 3 |

The sub-sampled Viterbi-Viterbi phase estimation and correction block 205 represents the operations/functions that are performed to generate Viterbi-Viterbi phase error corrected signals, shown in FIG. 4 as symbols R1′ though R12′. In this example, the sub-sampled Viterbi-Viterbi phase estimation and correction block 205 corresponds to the 4^{th}-power function operations, the adder tree operations, the unwrapping operations, and the symbol rotation operations described above. As noted elsewhere herein, in certain examples only symbols that will used for the sub-sampled Maximum-Likelihood stage 250 are rotated before the Maximum-Likelihood stage 250 to reduce complexity.

As a result of the processing described above, the plurality of Viterbi-Viterbi phase error corrected symbols R1′ though R12′ (or a subset thereof) are provided to the Maximum-Likelihood stage 250. The Maximum-Likelihood stage 250 comprises sub-sampling selection logic 225, a sub-sampled Maximum-Likelihood phase estimation block 226, and a symbol rotation segment 234.

Sub-sampling selection logic 225 is configured to receive the Viterbi-Viterbi phase error corrected symbols R1′ though R12′ and is configured to select a subset of these symbols R1′ through R12′ for processing by the subsequent segments in the Maximum-Likelihood stage 250. The sub-sampling selection logic 225 may be implemented in a manner similar to the arrangement of FIG. 2B. In general, the symbols selected for subsequent use are the symbols that provide the most phase information about the optical signal that is relevant for the subsequent Maximum-Likelihood operations. More specifically, depending on the constellation symbol a certain phase error (angle) translates into error vectors with varying length. First ring symbols translate into the shortest length vector, second ring symbols translate into a medium length vector, and third ring symbols translate into the longest vector. The Additive white Gaussian noise that impairs the phase error estimation is independent of the constellation symbol. Consequently, the ratio between the measured signal phase error and additive white Gaussian noise varies with the diameter of each ring, where first ring symbols provide a weak phase estimate, second ring symbols provide a medium phase estimate, and third ring symbols provide a strong phase estimate. In other words, outer constellations have better phase information.

In the example of FIG. 4, the 12 Viterbi-Viterbi phase error corrected symbols R1′ though R12′ are divided into six (6) groups 230(1)-230(6) that each comprise two sequential symbols (i.e., symbol pairs). For example, group 230(1) includes symbols R1′ and R2′, group 230(2) includes symbols R3′ and R4′, and so on. The sub-sampling logic 225 is configured to evaluate the symbols within a group to select the symbol in that group that will provide the most phase information about the optical signal that is relevant for the subsequent Maximum-Likelihood operations (i.e., the symbol having the highest ratio between the measured signal phase error and additive noise). For example, as noted previously, group 230(1) comprises symbols R1′ and R2′. R1′ falls within the third ring 120, while R2′ falls within the second ring 115. Third ring symbols have the highest ratio between the measured signal phase error and additive noise, while second ring symbols have the second highest ratio between the measured signal phase error and additive noise. As such, symbol R1′ is selected from group 230(1) for subsequent processing, while symbol R2′ is discarded (i.e., omitted for use in processing by the sub-sampled Maximum-Likelihood phase estimation block 226).

As a further example, group 230(2) comprises symbols R3′ and R4′. R3′ falls within the second ring 115, while R4′ falls within the third ring 120. Second ring symbols have the second highest ratio between the measured signal phase error and additive noise, while first ring symbols have the lowest ratio between the measured signal phase error and additive noise. As such, from group 230(2) symbol R3′ is selected for subsequent processing, while symbol R4′ is discarded.

The symbols that are selected from each group 230(1)-230(6) are circled in FIG. 4. Additionally, Table 6 below illustrates each of the groups 230(1)-230(6), the symbols in each group, and the symbol that is selected for subsequent Maximum-Likelihood stage operations, and the selected symbol ring classification.

TABLE 6

| | First Group | Second Group | Selected | Selected Symbol |
|---|---|---|---|---|
| Group | Member | Member | Symbol | Ring |
| 230(1) | Symbol R1′ | Symbol R2′ | Symbol R1′ | Ring 3 |
| 230(2) | Symbol R3′ | Symbol R4′ | Symbol R3′ | Ring 2 |
| 230(3) | Symbol R5′ | Symbol R6′ | Symbol R5′ | Ring 2 |
| 230(4) | Symbol R7′ | Symbol R8′ | Symbol R7′ | Ring 2 |
| 230(5) | Symbol R9′ | Symbol R10′ | Symbol R10′ | Ring 3 |
| 230(6) | Symbol R11′ | Symbol R12′ | Symbol R11′ | Ring 3 |

The sub-sampling selection logic 225 comprises one or more hardware elements (e.g., switches, multiplexers, etc.) that use the ring partitioning segment information to select the appropriate symbols. In essence, the sub-sampling selection logic 225 is configured to perform a comparison of the symbols within a group 230(1)-230(6) to determine which one has the relative highest ratio between the measured signal phase error and additive noise. If both the Viterbi-Viterbi and Maximum-Likelihood stages are sub-sampled, the vector-length and ring decisions do not need to be made again within the sub-sampling logic 225 (as they were already completed in sub-sampling logic 255). In such examples, only the symbol selection block changes.

FIG. 4 illustrates an example in which the groups 230(1)-230(6) each have two members and where one symbol is selected from each group. It is to be appreciated that these examples are merely illustrative and that other group sizes (e.g., groups of 4 symbols) are possible.

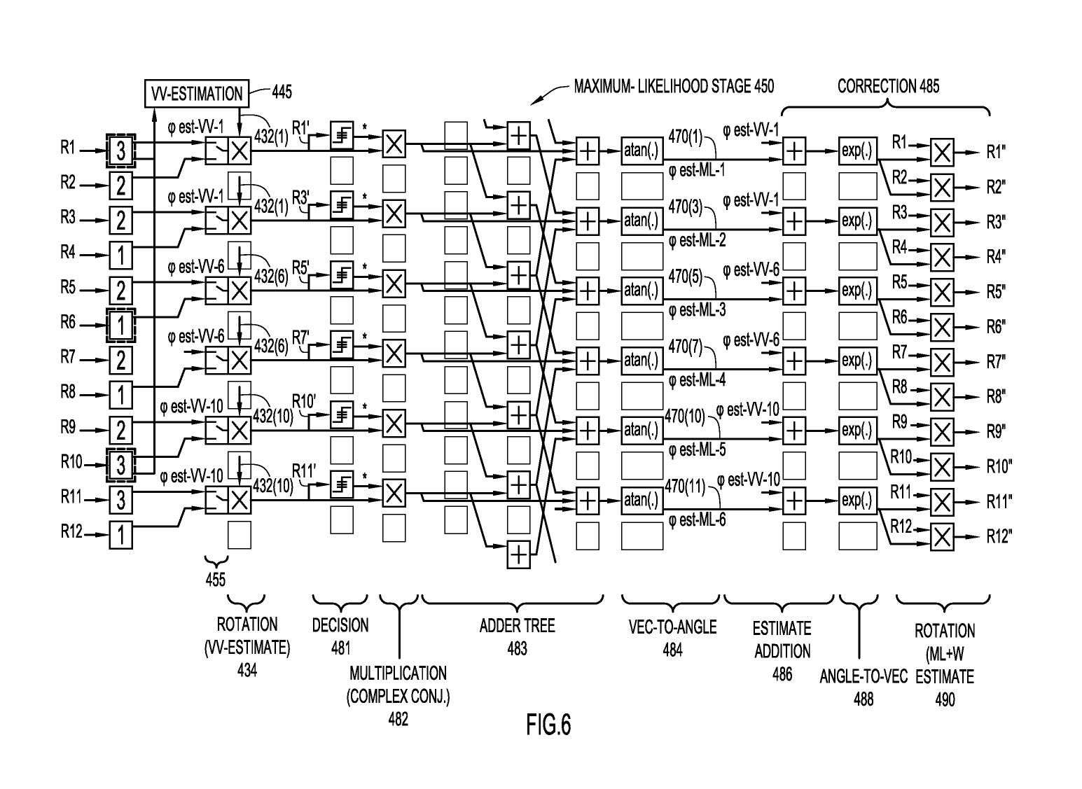

In the example of FIG. 4, as a result of the sub-sampling selection logic 225, six symbols are selected for processing by the sub-sampled Maximum-Likelihood phase estimation block 226. In general, the sub-sampled Maximum-Likelihood phase estimation block 226 is configured to perform Maximum-Likelihood operations using the six selected symbols (symbols R1′, R3′, R5′, R7′, R10′, and R11′) to generate a Maximum-Likelihood phase estimates (offset) 232(1)-232(6) for each group. Details of an example Maximum-Likelihood phase estimation block are provided below with reference to FIG. 6.

At the symbol rotation segment 235, the Maximum-Likelihood phase estimates 232(1)-232(6) are applied to the Viterbi-Viterbi phase error corrected symbols R1′ though R12′ in the respective group. More specifically, at the symbol rotation segment 235, each of the Viterbi-Viterbi phase error corrected symbols R1′ though R12′ are provided to an associated processing block 235(1)-235(12). Each block 235(1)-235(12) also receives a Maximum-Likelihood phase estimate for the corresponding group. For example, blocks 235(1) and 235(2) receive the Viterbi-Viterbi phase error corrected symbols R1′ and R2′, respectively. The blocks 235(1) and 235(2) also receive the Maximum-Likelihood phase estimate 232(1) corresponding to group 230(1) to which symbols R1′ and R2′ belong. That is, the Maximum-Likelihood phase estimate 232(1) generated from R1′ is used for the phase error correction of both symbols R1′ and R2′ at the symbol rotation segment 235. Table 7 below illustrates the Maximum-Likelihood phase estimate that is used to correct each of the symbols R1′ through R12′ at the symbol rotation segment 235.

TABLE 7

| Symbol | Correction Signal |
|---|---|
| Symbol R1′ | 232(1) |
| Symbol R2′ | 232(1) |
| Symbol R3′ | 232(2) |
| Symbol R4′ | 232(2) |
| Symbol R5′ | 232(3) |
| Symbol R6′ | 232(3) |
| Symbol R7′ | 232(4) |
| Symbol R8′ | 232(4) |
| Symbol R9′ | 232(5) |
| Symbol R10′ | 232(5) |
| Symbol R11′ | 232(6) |
| Symbol R12′ | 232(6) |

In certain embodiments, to reduce the overall complexity of the two stage carrier recovery, the Viterbi-Viterbi phase estimate is only applied to symbols that will be considered in the Maximum-Likelihood stage (R1′, R3′, R5′, R7′, R10′ and R11′) behind the Viterbi-Viterbi stage. And after Maximum-Likelihood phase error estimation the sum of the Viterbi-Viterbi estimate and the Maximum-Likelihood estimate is applied to all corresponding uncorrected symbols (R1-R12). Such an arrangement is shown below in FIG. 6.

The symbol rotation segment 235 is configured to output a plurality of complete phase error corrected signals, shown in FIG. 4 as symbols R1″ though R12″. These symbols R1″ through R12″ represent fully phase recovered symbols (i.e., symbols that have undergone both Viterbi-Viterbi and Maximum-Likelihood phase error recovery). The fully phase recovered symbols may be provided to a Forward Error Correction decoder for subsequent processing.

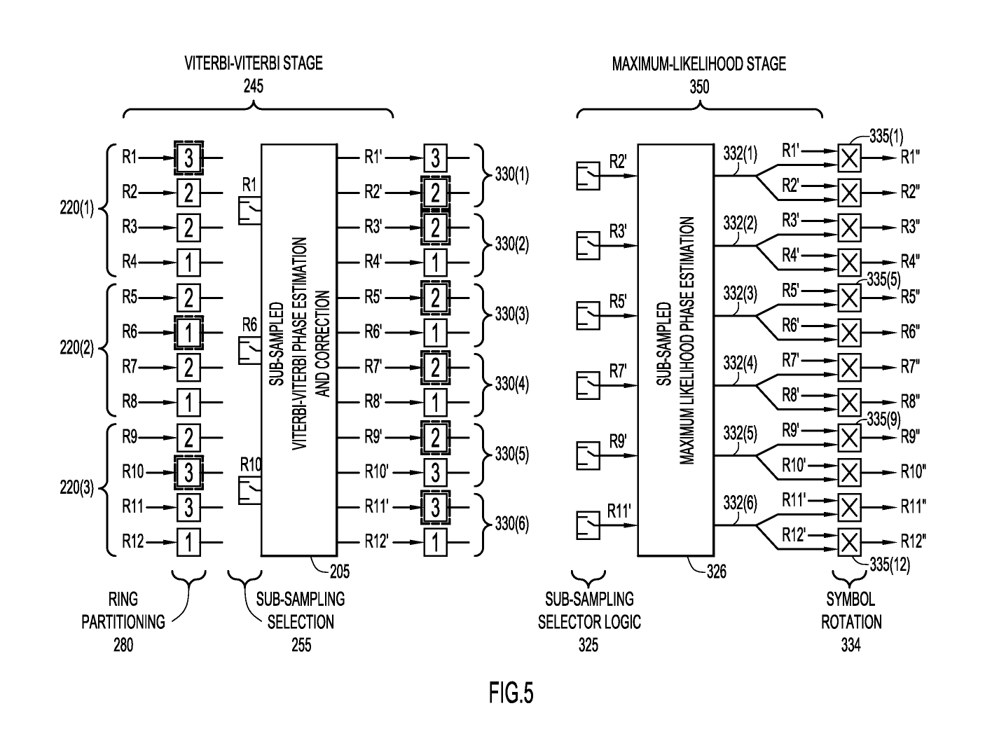

FIG. 5 is a schematic diagram illustrating alternative sub-sampling selection techniques in a Maximum-Likelihood stage 350 connected to Viterbi-Viterbi stage 245. Viterbi-Viterbi stage 245 operates as described above with reference to FIG. 4 to generate the plurality of Viterbi-Viterbi phase error corrected symbol R1′ though R12′. As a result, the plurality of Viterbi-Viterbi phase error corrected symbols R1′ though R12′ are provided to the Maximum-Likelihood stage 350. The Maximum-Likelihood stage 350 comprises sub-sampling selection logic 325, a sub-sampled Maximum-Likelihood phase estimation block 326, and a symbol rotation segment 334.

Similar to sub-sampling selection logic 225 of FIG. 4, the sub-sampling selection logic 325 is configured to select a subset of the received symbols R1′ through R12′ for processing by the subsequent segments in the Maximum-Likelihood stage 350. In general, the symbols selected for subsequent use are the symbols that have the highest ratio between the measured signal phase error and additive noise. However, in addition to selecting the symbols that have the highest ratio between the measured signal phase error and additive noise, the sub-sampling selection logic 325 is also configured to only select symbols for which a precursor to that symbol was not used in the Viterbi-Viterbi stage operations. In other words, if a symbol is used in the Viterbi-Viterbi stage 245, the sub-sampling selection logic 325 is configured to eliminate the Viterbi-Viterbi phase error corrected version of that symbol for use in the Maximum-Likelihood stage 350. In essence, the sub-sampling selection logic 325 performs a two-stage selection process that eliminates Viterbi-Viterbi phase error corrected versions of symbols used in the Viterbi-Viterbi stage 245 and that, from the remaining symbols, selects the one that has the highest ratio between the measured signal phase error and additive noise. This guarantees maximum utilization of the available information about the actual phase error, since the previously unused symbols will contain the phase-error and an uncorrelated noise component which can be averaged.

In the example of FIG. 5, the 12 Viterbi-Viterbi phase error corrected symbols R1′ though R12′ are divided into six (6) groups 330(1)-330(6). The groups 330(1)-330(6) in this each comprise two sequential symbols (i.e., a pair of symbols). For example, group 330(1) includes symbols R1′ and R2′, group 330(2) includes symbols R3′ and R4′, and so on.

As noted, the sub-sampling logic 325 performs a two-stage selection process to evaluate the symbols within a group to select a symbol in that group that will provide the most phase information about the optical signal that is relevant for phase error estimation in the subsequent Maximum-Likelihood operations. For example, group 330(1) comprises Viterbi-Viterbi phase error corrected signals symbols R1′ and R2′. R1′ falls within the third ring 120, while R2′ falls within the second ring 115. Again, third ring symbols have the highest ratio between the measured signal phase error and additive noise, while second ring symbols have the second highest ratio between the measured signal phase error and additive noise. However, symbol R1 (the precursor to symbol R1′) was selected from group 220(1) in the Viterbi-Viterbi stage 245. As such, sub-sampling selection logic 325 eliminates symbol R1′ from use in the Maximum-Likelihood stage 350. Accordingly, sub-sampling selection logic 325 selects symbol R2′ for subsequent processing.

As a further example, group 330(2) comprises symbols R3′ and R4′. R3′ falls within the second ring 115, while R4′ falls within the third ring 120. Neither of the precursors for symbols R3′ or R4′ (i.e., symbols R3 or R4) were used in the Viterbi-Viterbi stage. As such, since second ring symbols have the second highest ratio between the measured signal phase error and additive noise, while first ring symbols have the lowest ratio between the measured signal phase error and additive noise, symbol R3′ is selected from group 330(2) for subsequent processing and symbol R4′ is discarded.

In another example, group 330(5) comprises symbols R9′ and R10′. R9′ falls within the second ring 115, while R20′ falls within the third ring 110. Third ring symbols have the highest ratio between the measured signal phase error and additive noise, while second ring symbols have the second highest ratio between the measured signal phase error and additive noise. However, symbol R10 (the precursor to symbol R10′) was selected from group 220(3) in the Viterbi-Viterbi stage 245. As such, sub-sampling selection logic 325 eliminates symbol R10′ from use in the Maximum-Likelihood stage 350. Accordingly, sub-sampling selection logic 325 selects symbol R9′ for subsequent processing.

The symbols that are selected from each group 330(1)-330(6) are circled in FIG. 5. Additionally, Table 8 below illustrates each of the groups 330(1)-330(6), the symbols in each group, the symbol that is selected for subsequent Maximum-Likelihood stage operations, and the selected symbol ring classification.

TABLE 8

| | First Group | Second Group | Selected | Selected Symbol |
|---|---|---|---|---|
| Group | Member | Member | Symbol | Ring |
| 330(1) | Symbol R1′ | Symbol R2′ | Symbol R2′ | Ring 2 |
| 330(2) | Symbol R3′ | Symbol R4′ | Symbol R3′ | Ring 2 |
| 330(3) | Symbol R5′ | Symbol R6′ | Symbol R5′ | Ring 2 |
| 330(4) | Symbol R7′ | Symbol R8′ | Symbol R7′ | Ring 2 |
| 330(5) | Symbol R9′ | Symbol R10′ | Symbol R9′ | Ring 2 |
| 330(6) | Symbol R11′ | Symbol R12′ | Symbol R11′ | Ring 3 |

The sub-sampling selection logic 325 comprises one or more hardware elements (e.g., switches, multiplexers, etc.) that use the ring partitioning segment information to select the appropriate symbols. In essence, the sub-sampling selection logic 325 is configured to perform a two-stage analysis of the symbols within a group 330(1)-330(6). First, the sub-sampling selection logic 325 eliminates any symbols for which a precursor of the symbols was used in the Viterbi-Viterbi stage 245. Second, the sub-sampling selection logic 325 selects, from any remaining symbols, the symbol that have the highest ratio between the measured signal phase error and additive noise.

FIG. 5 illustrates an example in which the groups 330(1)-330(6) each have two members and where one symbol is selected from each group. It is to be appreciated that these examples are merely illustrative and that other group sizes (e.g., groups of 4 symbols) are possible.

In the example of FIG. 5, as a result of the sub-sampling selection logic 325, six symbols are selected for processing by the sub-sampled Maximum-Likelihood phase estimation block 326. In general, the sub-sampled Maximum-Likelihood phase estimation block 326 is configured to perform Maximum-Likelihood operations using the six selected symbols (symbols R2′, R3′, R5′, R7′, R9′, and R11′) to generate a Maximum-Likelihood phase estimates (offset) 332(1)-332(6) for each group.

At the symbol rotation segment 334, the Maximum-Likelihood phase estimates 332(1)-332(6) are then applied to the Viterbi-Viterbi phase error corrected symbols R1′ though R12′ in the respective group. More specifically, at the symbol rotation segment 334, each of the Viterbi-Viterbi phase error corrected symbols R1′ though R12′ are provided to an associated processing block 335(1)-335(12). Each block 335(1)-335(12) also receives a Maximum-Likelihood phase estimate for the corresponding group. For example, blocks 335(1) and 335(2) receive the Viterbi-Viterbi phase error corrected symbols R1′ and R2′, respectively. The blocks 335(1) and 335(2) also receive the Maximum-Likelihood phase estimate 332(1) corresponding to group 330(1) to which symbols R1′ and R2′ belong. That is, the Maximum-Likelihood phase estimate 332(1) generated from R2′ is used for the phase error correction of both symbols R1′ and R2′ at the symbol rotation segment 334. Table 9, below, illustrates the Maximum-Likelihood phase estimate that is used to correct each of the symbols R1′ through R12′ at the symbol rotation segment 335.

TABLE 9

| Symbol | Correction Signal |
|---|---|
| Symbol R1′ | 332(1) |
| Symbol R2′ | 332(1) |
| Symbol R3′ | 332(2) |
| Symbol R4′ | 332(2) |
| Symbol R5′ | 332(3) |
| Symbol R6′ | 332(3) |
| Symbol R7′ | 332(4) |
| Symbol R8′ | 332(4) |
| Symbol R9′ | 332(5) |
| Symbol R10′ | 332(5) |
| Symbol R11′ | 332(6) |
| Symbol R12′ | 332(6) |

The symbol rotation segment 334 is configured to output a plurality of complete phase error corrected signals, shown in FIG. 5 as symbols R1″ though R12″. These symbols R1″ through R12″ represent fully phase recovered symbols.

FIG. 6 is a schematic diagram of another two-stage carrier phase estimation with sub-sampled Viterbi-Viterbi and Maximum-Likelihood carrier phase estimation stages in accordance with examples presented herein. More specifically, FIG. 6 illustrates an arrangement where the Viterbi-Viterbi phase estimate is only applied to symbols that will be considered in the Maximum-Likelihood stage behind the Viterbi-Viterbi stage. After the Maximum-Likelihood phase error estimation, the sum of the Viterbi-Viterbi estimate and the Maximum-Likelihood estimate is applied to all corresponding uncorrected symbols (R1-R12).

FIG. 6 illustrates a Viterbi-Viterbi stage 445 that is substantially similar to the Viterbi-Viterbi stage 245 of FIG. 4. That is, the Viterbi-Viterbi stage 445 operates as described above to generate the plurality of Viterbi-Viterbi estimated phase corrections from the symbols selected through the sub-sampling techniques, in this case symbols R1, R6, and R10. The generated Viterbi-Viterbi estimated phase corrections generated from R1, R6, and R10 are shown in FIG. 6 as Viterbi-Viterbi estimated phase corrections 432(1), 432(6), and 432(10), respectively.

Unlike in the above example of FIG. 4, the Viterbi-Viterbi stage 445 does not apply the Viterbi-Viterbi estimated phase corrections 432(1), 432(6), and 432(10) to the original symbols R1-R12. Instead, the Viterbi-Viterbi estimated phase corrections 432(1), 432(6), and 432(10) are provided to a rotation segment 434 coupled to sub-sampling logic 455. The symbols R1-R12 are grouped in six (6) pairs. The sub-sampling logic 455 operates to select the symbol from each pair that, as detailed above, has highest ratio between the measured signal phase error and additive noise (outmost ring). Only the six symbols selected by the sub-sampling logic 455 receive Viterbi-Viterbi phase correction at rotation segment 434.

The rotation segment 434 generates six Viterbi-Viterbi phase error corrected symbols, namely R1′, R3′, R5′, R7′, R10′, and R11′ that correspond to the symbols selected by the sub-sampling logic 455. These Viterbi-Viterbi phase error corrected symbols are provided to Maximum-Likelihood stage 450 that comprises a decision segment 481, multiplication segment 482, an adder tree segment 483, and a vector-to-angle conversion segment 484. The segments 481, 482, 483, and 484 collectively operate to generate six Maximum-Likelihood estimated phase corrections, shown in FIG. 6 as 470(1), 470(3), 470(5), 470(7), 470(10), and 470(11) that correspond to Viterbi-Viterbi phase error corrected symbols, namely R1′, R3′, R5′, R7′, R10′, and R11′, respectively.

Also shown in FIG. 6 is a correction block 485 that comprises an estimate addition segment 486, an angle-to-vector conversion segment 488, and a rotation segment 490. The estimate addition segment 484 sums the Viterbi-Viterbi estimated phase corrections 432(1), 432(6), and 432(10) and the corresponding Maximum-Likelihood estimated phase corrections 470(1), 470(3), 470(5), 470(7), 470(10), and 470(11) (i.e., generates combined estimated phase corrections). After angle-to-vector conversion segment 488, the combined estimated phase corrections are applied to all corresponding uncorrected symbols (R1-R12) at rotation segment 490 to generate fully phase recovered symbols R1″-R12″.

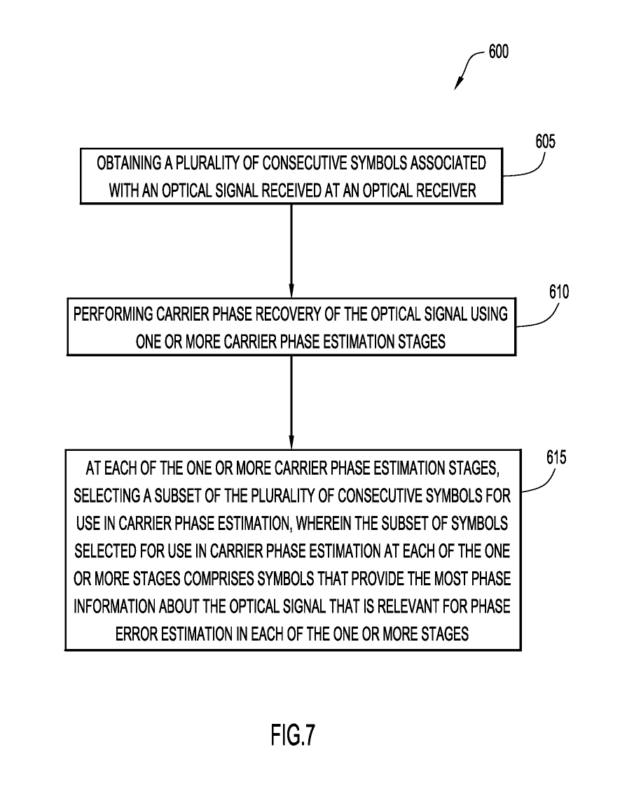

FIG. 7 is a flowchart of a method 600 in accordance with examples presented. Method 600 begins at 605 where a plurality of consecutive symbols associated with an optical signal received at an optical receiver is obtained. For example, the optical signal was transmitted over an optical fiber span by a transmitter and received at the optical receiver. At 610, carrier phase recovery of the optical signal is performed using one or more carrier phase estimation stages. At 615, a subset of the plurality of consecutive symbols is selected for use in carrier phase estimation. The subset of symbols selected for use in carrier phase estimation at each of the one or more stages comprises symbols that provide the most phase information about the optical signal that is relevant for phase error estimation in each of the one or more stages.

In certain examples, the one or more carrier phase estimation stages include a Viterbi-Viterbi carrier phase estimation stage that generates Viterbi-Viterbi phase error corrected symbols. In such embodiments, the selection of the subset of the plurality of consecutive symbols for carrier phase estimation may include performing ring partitioning of the symbols to determine within which of a first, second, or third constellation radius ring each of the symbols falls, organizing the plurality of consecutive symbols into a plurality of groups, and selecting, from each of the plurality of groups, a symbol that has the highest ratio between the measured signal phase error and additive noise and is useable in a given phase error estimation stage.

The above description is intended by way of example only.

What is claimed is:

1. A method comprising:
obtaining a plurality of consecutive symbols associated with an optical signal received at an optical receiver;
performing carrier phase recovery of the optical signal using one or more carrier phase estimation stages to generate a phase recovered signal; and
at each of the one or more carrier phase estimation stages, selecting a subset of the plurality of consecutive symbols for use in carrier phase estimation, wherein the subset of symbols selected for use in carrier phase estimation at each of the one or more stages comprises symbols that provide the most phase information about the optical signal that is relevant for phase error estimation in each of the one or more stages.

2. The method of claim 1, wherein performing carrier phase recovery of the optical signal using one or more carrier phase estimation stages comprises:
performing carrier phase recovery using a Viterbi-Viterbi carrier phase estimation stage to generate Viterbi-Viterbi phase error corrected symbols.

3. The method of claim 2, wherein selecting a subset of the plurality of symbols for carrier phase estimation comprises:
performing ring partitioning of the symbols to determine within which of a first, second, or third constellation radius ring each of the symbols falls;
organizing the plurality of symbols into a plurality of groups of symbols consecutive in time;
discarding any symbols which fall in the second ring and are not usable in a 4^{th}-power function; and
selecting, from the symbols remaining in each of the plurality of groups, a symbol that has the highest ratio between measured signal phase error and additive noise.

4. The method of claim 2, wherein performing carrier phase recovery of the optical signal using one or more carrier phase estimation stages comprises:
performing carrier phase recovery using a Maximum-Likelihood carrier phase estimation stage, wherein the Maximum-Likelihood carrier phase estimation stage operates using a subset of the Viterbi-Viterbi phase error corrected symbols.

5. The method of claim 4, wherein selecting a subset of the plurality of symbols for carrier phase estimation comprises:
organizing the plurality of Viterbi-Viterbi phase error corrected symbols into a plurality of groups of symbols consecutive in time; and
selecting, from each of the plurality of groups of Viterbi-Viterbi phase error corrected symbols, a symbol with the highest ratio between measured signal phase error and additive noise.

6. The method of claim 4, wherein selecting a subset of the plurality of symbols for carrier phase estimation comprises:
organizing the plurality of Viterbi-Viterbi phase error corrected symbols into a plurality of groups;
discarding any Viterbi-Viterbi phase error corrected symbols for which a precursor of the Viterbi-Viterbi phase error corrected symbols was used in the Viterbi-Viterbi carrier phase estimation stage; and
selecting, from the one or more symbols remaining in each of the plurality of groups of Viterbi-Viterbi phase error corrected symbols, a Viterbi-Viterbi phase error corrected symbol with the highest ratio between the measured signal phase error and additive noise.

7. The method of claim 1, further comprising:
decoding the phase recovered signal with a forward error correction decoder.

8. An apparatus comprising:
a phase recovery module configured to perform carrier phase estimation using one or more stages; and
sub-sampling logic configured to receive a plurality of consecutive symbols associated with an optical signal and configured to select a subset of the plurality of consecutive symbols for use in carrier phase estimation to obtain a phase recovered signal, wherein the subset of symbols selected for use in carrier phase estimation at each of the one or more stages comprise symbols that provide the most phase information about the optical signal that is relevant for phase error estimation in each of the one or more stages.

9. The apparatus of claim 8, wherein the phase recovery module comprises a Viterbi-Viterbi carrier phase estimation stage configured to generate Viterbi-Viterbi phase error corrected symbols.

10. The apparatus of claim 9, wherein the sub-sampling logic is configured to:
perform ring partitioning of the symbols to determine within which of a first, second, or third constellation radius ring each of the symbols falls;
organize the plurality of symbols into a plurality of groups of symbols consecutive in time;
discard any symbols which fall in the second ring and are not usable in a 4^{th}-power function; and
select, from the symbols remaining in each of the plurality of groups, a symbol that has the highest ratio between measured signal phase error and additive noise.

11. The apparatus of claim 9, wherein the phase recovery module further comprises a Maximum-Likelihood carrier phase estimation stage, wherein the Maximum-Likelihood carrier phase estimation stage operates using a subset of the Viterbi-Viterbi phase error corrected symbols.

12. The apparatus of claim 11, wherein the sub-sampling logic is configured to:
organize the plurality of Viterbi-Viterbi phase error corrected symbols into a plurality of groups of symbols consecutive in time; and
select, from each of the plurality of groups of Viterbi-Viterbi phase error corrected symbols, a symbol with the highest ratio between measures signal phase error and additive noise.

13. The apparatus of claim 11, wherein the sub-sampling logic is configured to:
organize the plurality of Viterbi-Viterbi phase error corrected symbols into a plurality of groups;
discard any Viterbi-Viterbi phase error corrected symbols for which a precursor of the Viterbi-Viterbi phase error corrected symbols was used in the Viterbi-Viterbi carrier phase estimation stage; and
select, from the one or more symbols remaining in each of the plurality of groups of Viterbi-Viterbi phase error corrected symbols, a Viterbi-Viterbi phase error corrected symbol with the highest ratio between the measured signal phase error and additive noise.

14. The apparatus of claim 8, further comprising a forward error correction decoder configured to decode the phase recovered signal.

15. A method comprising:
obtaining a plurality of consecutive symbols associated with an optical signal received at an optical receiver;
grouping the plurality of consecutive symbols into a plurality of groups of symbols consecutive in time; and
from each of the plurality of groups, selecting the symbol having the relative highest ratio between measured signal phase error and additive noise to generate a subset of received symbols; and
performing carrier phase recovery at one or more carrier phase estimation stages using the subset of received symbols to obtain a phase recovered signal.

16. The method of claim 15, wherein performing carrier phase recovery of the optical signal using one or more carrier phase estimation stages comprises:
performing carrier phase recovery using a Viterbi-Viterbi carrier phase estimation stage to generate Viterbi-Viterbi phase error corrected symbols.

17. The method of claim 16, wherein selecting the symbol having the relative highest ratio between the measured signal phase error and additive noise to generate a subset of received symbols comprises:
performing ring partitioning of the symbols to determine within which of a first, second, or third constellation radius ring each of the symbols falls;
organizing the plurality of symbols into the plurality of groups of symbols consecutive in time; and
selecting, from each of the plurality of groups, a symbol that that has the highest ratio between the measured signal phase error and additive noise and is useable in a 4^{th}-power function.

18. The method of claim 16, wherein performing carrier phase recovery of the optical signal using one or more carrier phase estimation stages comprises:
performing carrier phase recovery using a Maximum-Likelihood carrier phase estimation stage, wherein the Maximum-Likelihood carrier phase estimation stage operates using a subset of the Viterbi-Viterbi phase error corrected symbols.

19. The method of claim 18, further comprising:
organizing the plurality of Viterbi-Viterbi phase error corrected symbols into a plurality of groups;
discarding any Viterbi-Viterbi phase error corrected symbols for which a precursor of the Viterbi-Viterbi phase error corrected symbols was used in the Viterbi-Viterbi carrier phase estimation stage; and
selecting, from the one or more symbols remaining in each of the plurality of groups of Viterbi-Viterbi phase error corrected symbols, a Viterbi-Viterbi phase error corrected symbol with the highest ratio between the measured signal phase error and additive noise.

20. The method of claim 15, further comprising:
decoding the phase recovered signal with a forward error correction decoder.
